(19) United States
(12) Patent Application Publication
(10) Pub. No.: US 2013/0098458 A1
(43) Pub. Date: Apr. 25, 2013

(54) HYDRAULIC SYSTEM HAVING MULTIPLE CLOSED-LOOP CIRCUITS

(71) Applicant: Michael L. Knussman, East Peoria, IL (US)

(72) Inventor: Michael L. Knussman, East Peoria, IL (US)

(21) Appl. No.: 13/278,589

(22) Filed: Oct. 21, 2011

(51) Int. Cl. F17D 1/00; F17D 3/00

(52) U.S. Cl. 137/2; 137/563

(57) ABSTRACT

A hydraulic system is disclosed. The hydraulic system may have a first circuit fluidly connecting a first pump to a swing motor and to a first travel motor in a parallel closed-loop manner. The hydraulic system may also have a second circuit fluidly connecting a second pump to a second travel motor and to a first linear tool actuator in a parallel closed-loop manner.

### TECHNICAL FIELD

The present disclosure relates generally to a hydraulic system and, more particularly, to a closed-loop hydraulic system having multiple closed-loop circuits.

### BACKGROUND

A conventional hydraulic system includes a pump that draws low-pressure fluid from a tank, pressurizes the fluid, and makes the pressurized fluid available to multiple different actuators for use in moving the actuators. In this arrangement, a speed of each actuator can be independently controlled by selectively throttling (i.e., restricting) a flow of the pressurized fluid from the pump into each actuator. For example, to move a particular actuator at a high speed, the flow of fluid from the pump into the actuator is restricted by only a small amount. In contrast, to move the same or another actuator at a low speed, the restriction placed on the flow of fluid is increased. Although adequate for many applications, the use of fluid restriction to control actuator speed can result in flow losses that reduce an overall efficiency of a hydraulic system.

An alternative type of hydraulic system is known as a closed-loop hydraulic system. A closed-loop hydraulic system generally includes a pump connected in closed-loop fashion to a single actuator or to a pair of actuators operating in tandem. During operation, the pump draws fluid from one chamber of the actuator(s) and discharges pressurized fluid to an opposing chamber of the same actuator(s). To move the actuator(s) at a higher speed, the pump discharges fluid at a faster rate. To move the actuator(s) with a lower speed, the pump discharges the fluid at a slower rate. A closed-loop hydraulic system is generally more efficient than a conventional hydraulic system because the speed of the actuator(s) is controlled through pump operation as opposed to fluid restriction. That is, the pump is controlled to only discharge as much fluid as is necessary to move the actuator(s) at a desired speed, and no throttling of a fluid flow is required.

An exemplary closed-loop hydraulic system is disclosed in U.S. Pat. No. 4,369,625 of Izumi et al. that published on Jan. 25, 1983 (the '625 patent). In the '625 patent, a multi-actuator meterless-type hydraulic system is described that has flow combining functionality. The hydraulic system includes a swing circuit, a boom circuit, a stick circuit, a bucket circuit, a left travel circuit, and a right travel circuit. Each of the swing, boom, stick, and bucket circuits has a pump connected to a specialized actuator in a closed-loop manner. In addition, a first combining valve is connected between the swing and stick circuits, a second combining valve is connected between the stick and boom circuits, and a third combining valve is connected between the bucket and boom circuits. The left and right travel circuits are connected in parallel to the pumps of the bucket and boom circuits, respectively. In this configuration, any one actuator can receive pressurized fluid from more than one pump such that its speed is not limited by the capacity of a single pump.

Although an improvement over existing closed-loop hydraulic systems, the closed-loop hydraulic system of the '625 patent described above may still be less than optimal. In particular, operation of connected circuits of the system may only be sequentially performed. In addition, the speeds and forces of the various actuators may be difficult to control.

The hydraulic system of the present disclosure is directed toward solving one or more of the problems set forth above and/or other problems of the prior art.

### SUMMARY

In one aspect, the present disclosure is directed to a hydraulic system. The hydraulic system may include a first circuit fluidly connecting a first pump to a swing motor and to a first travel motor in a parallel closed-loop manner. The hydraulic system may also include a second circuit fluidly connecting a second pump to a second travel motor and to a first linear tool actuator in a parallel closed-loop manner.

In another aspect, the present disclosure is directed to a method of operating a hydraulic system. The method may include pressurizing fluid with a first pump and a second pump, and directing fluid from the first pump to a swing motor and to a first travel motor, and from the swing and travel motors back to the first pump via a closed-loop first circuit. The method may also include directing fluid from the second pump to a first travel motor and to a first linear tool actuator in parallel, and from travel motor and the first linear tool actuator back to the second pump via a closed-loop second circuit.

### BRIEF DESCRIPTION OF THE DRAWINGS

FIG. 1 is a pictorial illustration of an exemplary disclosed machine; and

FIG. 2 is a schematic illustration of an exemplary disclosed hydraulic system that may be used in conjunction with the machine of FIG. 1.

### DETAILED DESCRIPTION

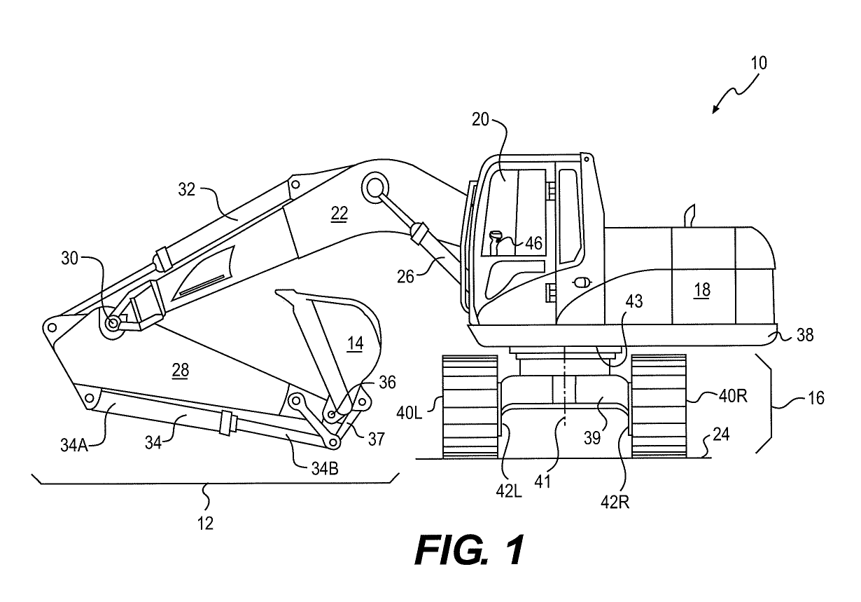

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be an earth moving machine such as an excavator (shown in FIG. 1), a dozer, a loader, a backhoe, a motor grader, a dump truck, or any other earth moving machine. Machine 10 may include an implement system 12 configured to move a work tool 14, a drive system 16 for propelling machine 10, a power source 18 that provides power to implement system 12 and drive system 16, and an operator station 20 situated for manual control of implement system 12, drive system 16, and/or power source 18.

Implement system 12 may include a linkage structure acted on by fluid actuators to move work tool 14. Specifically, implement system 12 may include a boom 22 that is vertically pivotal about a horizontal axis (not shown) relative to a work surface 24 by a pair of adjacent, double-acting, hydraulic cylinders 26 (only one shown in FIG. 1). Implement system 12 may also include a stick 28 that is vertically pivotal about a horizontal axis 30 by a single, double-acting, hydraulic cylinder 32. Implement system 12 may further include a single, double-acting, hydraulic cylinder 34 that is operatively connected between stick 28 and work tool 14 to pivot work tool 14 vertically about a horizontal pivot axis 36. In the disclosed embodiment, hydraulic cylinder 34 is connected at a head-end 34A to a portion of stick 28 and at an opposing rod-end 34B to work tool 14 by way of a power link 37. Boom 22 may be pivotally connected to a body 38 of machine 10. Body 38 may be pivotally connected to an undercarriage 39 and movable about a vertical axis 41 by a hydraulic swing motor 43. Stick 28 may pivotally connect boom 22 to work tool 14 by way of axis 30 and 36.

Numerous different work tools 14 may be attachable to a single machine 10 and operator controllable. Work tool 14 may include any device used to perform a particular task such as, for example, a bucket, a fork arrangement, a blade, a shovel, a ripper, a dump bed, a broom, a snow blower, a propelling device, a cutting device, a grasping device, or any other task-performing device known in the art. Although connected in the embodiment of FIG. 1 to pivot in the vertical direction relative to body 38 of machine 10 and to swing in the horizontal direction, work tool 14 may alternatively or additionally rotate, slide, open and close, or move in any other manner known in the art.

Drive system 16 may include one or more traction devices powered to propel machine 10. In the disclosed example, drive system 16 includes a left track 40L located on one side of machine 10, and a right track 40R located on an opposing side of machine 10. Left track 40L may be driven by a left-travel motor 42L, while right track 40R may be driven by a right-travel motor 42R. It is contemplated that drive system 16 could alternatively include traction devices other than tracks such as wheels, belts, or other known traction devices. Machine 10 may be steered by generating a speed and/or rotational direction difference between left and right-travel motors 42L, 42R, while straight travel may be facilitated by generating substantially equal output speeds and rotational directions from left and right-travel motors 42L, 42R.

Power source 18 may embody an engine such as, for example, a diesel engine, a gasoline engine, a gaseous fuel-powered engine, or any other type of combustion engine known in the art. It is contemplated that power source 18 may alternatively embody a non-combustion source of power such as a fuel cell, a power storage device, or another source known in the art. Power source 18 may produce a mechanical or electrical power output that may then be converted to hydraulic power for moving hydraulic cylinders 26, 32, 34 and left travel, right travel, and swing motors 42L, 42R, 43.

Operator station 20 may include devices that receive input from a machine operator indicative of desired machine maneuvering. Specifically, operator station 20 may include one or more operator interface devices 46, for example a joystick, a steering wheel, or a pedal, that are located proximate an operator seat (not shown). Operator interface devices 46 may initiate movement of machine 10, for example travel and/or tool movement, by producing displacement signals that are indicative of desired machine maneuvering. As an operator moves interface device 46, the operator may affect a corresponding machine movement in a desired direction, with a desired speed, and/or with a desired force.

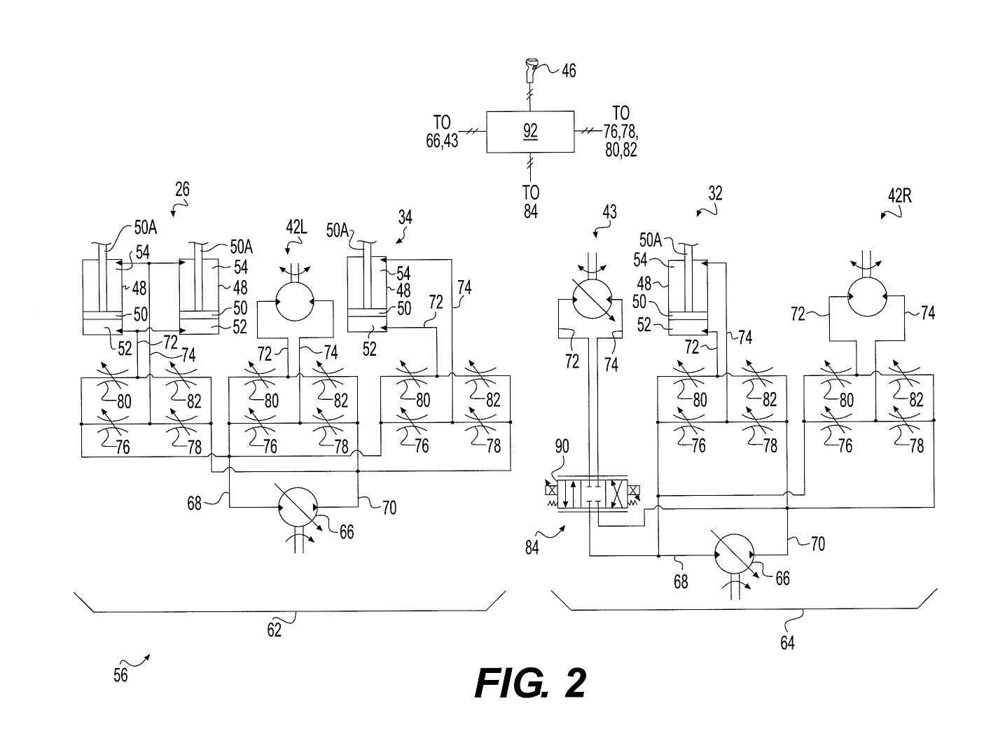

As shown in FIG. 2, hydraulic cylinders 26, 32, 34 may each include a tube 48 and a piston assembly 50 arranged within tube 48 to form a first chamber 52 and an opposing second chamber 54. In one example, a rod portion 50A of piston assembly 50 may extend through an end of second chamber 54. As such, second chamber 54 may be considered the rod-end chamber of hydraulic cylinders 26, 32, 34, while first chamber 52 may be considered the head-end chamber.

First and second chambers 52, 54 may each be selectively supplied with pressurized fluid and drained of the pressurized fluid to cause piston assembly 50 to displace within tube 48, thereby changing an effective length of hydraulic cylinders 26, 32, 34 and moving work tool 14 (referring to FIG. 1). A flow rate of fluid into and out of first and second chambers 52, 54 may relate to a translational velocity of hydraulic cylinders 26, 32, 34, while a pressure differential between first and second chambers 52, 54 may relate to a force imparted by hydraulic cylinders 26, 32, 34 on the associated linkage structure of implement system 12.

Swing motor 43, like hydraulic cylinders 26, 32, 34, may be driven by a fluid pressure differential. Specifically, swing motor 43 may include first and second chambers (not shown) located to either side of a pumping mechanism such as an impeller, plunger, or series of pistons (not shown). When the first chamber is filled with pressurized fluid and the second chamber is drained of fluid, the pumping mechanism may be urged to move or rotate in a first direction. Conversely, when the first chamber is drained of fluid and the second chamber is filled with pressurized fluid, the pumping mechanism may be urged to move or rotate in an opposite direction. The flow rate of fluid into and out of the first and second chambers may determine an output velocity of swing motor 43, while a pressure differential across the pumping mechanism may determine an output torque. Swing motor 43 may be an over-center variable displacement type motor having controls and equipment to support a load when changing displacement directions, such that for a given flow rate and/or pressure of supplied fluid, a speed, torque, and or rotational direction swing motor 43 may be adjusted. It is contemplated, however, that a displacement of swing motor 43 may alternatively be fixed and/or that swing motor 43 may not be an over-center motor, if desired.

Similar to swing motor 43, each of left and right-travel motors 42L, 42R may be driven by creating a fluid pressure differential. Specifically, each of left and right-travel motors 42L, 42R may include first and second chambers (not shown) located to either side of a pumping mechanism (not shown). When the first chamber is filled with pressurized fluid and the second chamber is drained of fluid, the pumping mechanism may be urged to move or rotate a corresponding traction device (40L, 40R) in a first direction. Conversely, when the first chamber is drained of the fluid and the second chamber is filled with the pressurized fluid, the respective pumping mechanism may be urged to move or rotate the traction device in an opposite direction. The flow rate of fluid into and out of the first and second chambers may determine a velocity of left and right-travel motors 42L, 42R, while a pressure differential between left and right-travel motors 42L, 42R may determine a torque. Left and right-travel motors 42L, 42R may be over-center variable-displacement type motors having controls and equipment to support a load when changing displacement directions, such that for a given flow rate and/or pressure of supplied fluid, a speed and/or torque output of travel motors 42L, 42R may be adjusted. It is contemplated, however, that left and right travel motors 42L, 42R may alternatively be fixed-displacement type motors and/or not over-center, if desired.

As illustrated in FIG. 2, machine 10 may include a hydraulic system 56 having a plurality of circuits that drive the fluid actuators described above to move work tool 14 (referring to FIG. 1) and machine 10. In particular, hydraulic system 56 may include, among other things, a first circuit 62 and a second circuit 64. First circuit 62 may be associated with hydraulic cylinders 26, left-travel motor 42L, and hydraulic cylinder 34. Second circuit 64 may be associated with swing motor 43, hydraulic cylinder 32, and right-travel motor 42R. It is contemplated that additional and/or different configurations of circuits may be included within hydraulic system 56 such as, for example, a charge circuit associated with each of first and second circuits 62, if desired.

In the disclosed embodiment, each of first and second circuits 62, 64 may be similar and include a plurality of interconnecting and cooperating fluid components that facilitate the use and control of the associated actuators. For example, each of first and second circuits 62, 64 may include a pump 66 fluidly connected to its associated actuators via a closed-loop formed by left-side and right-side (relative to FIG. 2) passages. Specifically, each of first and second circuits 62, 64 may include a left pump passage 68, a right pump passage 70, a left actuator passage 72 for each actuator, and a right actuator passage 74 for each actuator. For the linear actuators (e.g., hydraulic cylinders 26, 32, or 34), left and right actuator passages 72, 74 may be commonly known as head-end and rod-end passages, respectively. Within each of first and second circuit 62, 64, the corresponding pump 66 may be connected to its associated actuators via a combination of left and right, pump and actuator passages 68-74.

To extend a linear actuator (e.g., hydraulic cylinders 26, 32, or 34) or to cause a rotary actuator (e.g., left-travel, right-travel, or swing motor 42L, 42R, 43) to rotate in a first direction, left actuator passage 72 of a particular circuit may be filled with fluid pressurized by the associated pump 66, while corresponding right actuator passage 72 may be filled with fluid returned from the actuator. In contrast, to retract the linear actuator or to cause the rotary actuator to rotate in a second direction, right actuator passage 74 may be filled with fluid pressurized by the associated pump 66, while left actuator passage 72 may be filled with fluid exiting the actuator.

Each pump 66 may have variable displacement and be controlled to draw fluid from its associated actuators via left pump passage 68 and discharge the fluid at a specified elevated pressure back to the actuators in a single direction via right pump passage 70 (i.e., pumps 66 may be unidirectional pumps). That is, pump 66 may include a stroke-adjusting mechanism, for example a swashplate, a position of which is hydro-mechanically adjusted based on, among other things, a desired speed of the actuators to thereby vary an output (e.g., a discharge rate) of pump 66. The displacement of pump 66 may be adjusted from a zero displacement position at which substantially no fluid is discharged from pump 66, to a maximum displacement position at which fluid is discharged from pump 66 at a maximum rate into right pump passage 70. Pump 66 may be drivably connected to power source 18 of machine 10 by, for example, a countershaft, a belt, or in another suitable manner. Alternatively, pump 66 may be indirectly connected to power source 18 via a torque converter, a gear box, an electrical circuit, or in any other manner known in the art. It is contemplated that pumps 66 of first and second circuits 62, 64 may be connected to power source 18 in tandem (e.g., via the same shaft) or in parallel (via a gear train), as desired.

Pumps 66 of first and second circuits 62, 64 may have about the same capacities to discharge fluid. For example, pump 66 of first circuit 62 may have a slightly larger capacity of about 377 liters per minute (lpm), as the actuators of first circuit 62 may have the greatest combined demand for fluid. In contrast, pump 66 of second circuit 64 may have a slightly smaller capacity of about 322 lpm, as the actuators in second circuit 64 may have the lowest combined demands for fluid.

Pumps 66 may also be selectively operated as motors. More specifically, when an associated actuator is operating in an overrunning condition, the fluid discharged from the actuator may have a pressure elevated higher than an output pressure of the corresponding pump 66. In this situation, the elevated pressure of the actuator fluid directed back through pump 66 may function to drive pump 66 to rotate with or without assistance from power source 18. Under some circumstances, pump 66 may even be capable of imparting energy to power source 18, thereby improving an efficiency and/or capacity of power source 18.

During some operations, it may be desirable to cause movement of one actuator independent of movement of other actuators within the same circuit. For this purpose, each of first and second circuits 62, 64 may be provided with at least one metering valve for each actuator that is capable of substantially isolating one actuator from its associated pump 66 and/or other actuators of the same circuit, and also capable of independently controlling a speed of the associated actuator. In the disclosed embodiment, each of first and second circuits 62, 64 may include a set of four independent metering valves for each of hydraulic cylinders 26, 32, 34, including a first metering valve 76, a second metering valve 78, a third metering valve 80, and a fourth metering valve 82. First and second metering valves 76, 78 may be configured to regulate fluid flow into and out of one side of the associated actuator (e.g., into and out of second chamber 54 of a linear actuator). Third and fourth metering valves 80, 82 may be configured to similarly control fluid flow into and out of a second side of the associated actuator (e.g., into and out of first chamber 52). First and third metering valves 76, 80 may be associated with left pump passage 68, while second and fourth metering valves 78, 82 may be associated with right pump passage 70. During operation, one of first and second metering valves 76, 78 and one of third and fourth metering valves 80 82 will generally be passing fluid, while the remaining valves will generally be blocking fluid flow. And of the valves that are passing fluid, one will generally be passing fluid into the associated actuator, while the other will generally be passing fluid out of the associated actuator. In this manner, each set of four metering valves 76-82 may be utilized together to control a speed (through variable restriction of supply and return fluid flows) and a movement direction (through selective control of which of the valves are passing and blocking flows) of the associated actuator.

Each metering valve 76-82 may include a valve element movable to any position between a fully-open or flow-passing position and a fully-closed or flow-blocking position. Each metering valve 76-82 may be spring-biased toward the flow-blocking position and solenoid-operated to move toward the flow-passing position. It is contemplated that other configurations of valves may be utilized to meter fluid into and/or out of the actuators of hydraulic system 56, if desired, such as a common spool valve associated with each side of individual actuators or a single spool valve for each actuator, as desired.

In some embodiments, metering valves 76-82 may be used to facilitate fluid regeneration within the associated linear actuator. For example, when metering valves 76 and 80 are simultaneously moved to their flow-passing positions and metering valves 78 and 82 are in their flow-blocking positions, high-pressure fluid may be transferred from one chamber to the other of the linear actuator via metering valves 76 and 80, with only the rod volume of fluid (i.e., the volume displaced by rod portion 50A that is about equal to a difference between a first chamber volume and a second chamber volume) ever passing through pump 66. Similar functionality may alternatively be achieved by moving metering valves 78 and 82 to their flow-passing positions while holding metering valves 76 and 80 in their flow-blocking positions.

Second circuit 64 may also be provided with at least one metering valve for swing motor 43 that is capable of substantially isolating swing motor 43 from its associated pump 66 and/or from other actuators of second circuit 64, and also capable of independently controlling a speed of swing motor 43. In the disclosed embodiment, the at least one metering valve includes a single spool valve 84 having a valve element 90 capable of moving to any position between a first position, a second position, and a third position. When valve element 90 is in the first position (middle position shown in FIG. 2), fluid flow through valve 84 and swing motor 43 may be inhibited. When valve element 90 is in the second position (left position shown in FIG. 2), fluid from right pump passage 70 may flow into right actuator passage 74 and fluid from left actuator passage 72 may flow into left pump passage 68. When valve element 90 is in the third position (right position shown in FIG. 2), fluid from right pump passage 70 may flow into left actuator passage 72 and fluid from right actuator passage 74 may flow into left pump passage 68. Valve element 90 may be spring-biased toward the first position, and solenoid-operated toward either of the second or third positions.

First and second circuits 62, 64 may also each be provided with at least one metering valve for left and right travel motors 42L, 42R, respectively, that is capable of substantially isolating these motors from their associated pumps 66 and/or from other actuators of first and second circuits 62, 64, and also capable of independently controlling a speed of left and right travel motors 42L, 42R. In the disclosed embodiment, the at least one metering valve includes the set of four independent metering valves 76-82, substantially identical to the metering valves associated with hydraulic cylinders 26, 32, and 34. It should be noted, however, that left and right travel motors 42L, 42R could alternatively be controlled via one or more spool valves similar to valve 84, if desired.

During operation of machine 10, the operator may utilize interface device 46 to provide a signal that identifies a desired movement of the various linear and/or rotary actuators to a controller 92. Based upon one or more signals, including the signal from interface device 46 and, for example, signals from various pressure sensors and/or position sensors located throughout hydraulic system 56, controller 92 may command movement of the different valves and/or displacement changes of the different pumps and motors to advance a particular one or more of the linear and/or rotary actuators to a desired position in a desired manner (i.e., at a desired speed and/or with a desired force).

Controller 92 may embody a single microprocessor or multiple microprocessors that include components for controlling operations of hydraulic system 56 based on input from an operator of machine 10 and based on sensed or other known operational parameters. Numerous commercially available microprocessors can be configured to perform the functions of controller 92. It should be appreciated that controller 92 could readily be embodied in a general machine microprocessor capable of controlling numerous machine functions. Controller 92 may include a memory, a secondary storage device, a processor, and any other components for running an application. Various other circuits may be associated with controller 92 such as power supply circuitry, signal conditioning circuitry, solenoid driver circuitry, and other types of circuitry.

### INDUSTRIAL APPLICABILITY

The disclosed hydraulic system may be applicable to any machine where improved hydraulic efficiency and performance is desired. The disclosed hydraulic system may provide for improved efficiency through the use of closed-loop and meterless technology. The disclosed hydraulic system may provide for enhanced functionality and control through the selective use of novel circuit configurations. Operation of hydraulic system 56 will now be described.

During operation of machine 10, an operator located within station 20 may command a particular motion of work tool 14 in a desired direction and at a desired velocity by way of interface device 46. One or more corresponding signals generated by interface device 46 may be provided to controller 92 indicative of the desired motion, along with machine performance information, for example sensor data such a pressure data, position data, speed data, pump displacement data, and other data known in the art.

In response to the signals from interface device 46 and based on the machine performance information, controller 92 may generate control signals directed to pumps 66, swing motor 43, and/or to valves 76, 78, 80, 82, 90. For example, to rotate right-travel motor 42R at an increasing speed in the first direction, controller 92 may generate a control signal that causes pump 66 of second circuit 64 to increase its displacement and discharge fluid into right pump passage 70 at a greater rate. In addition, controller 92 may generate a control signal that causes metering valves 76 and 82 to move a greater extent toward and/or remain in their flow-passing positions. After fluid from pump 66 passes into and through right-travel motor 42R via right pump passage 70, the fluid may return to pump 66 via left pump passage 68. At this time, the speed of right-travel motor 42R may be dependent on a discharge rate of pump 66 and on a restriction amount, if any, provided by metering valves 76 and 82 on the flow of fluid passing through right-travel motor 42R. Movement of hydraulic cylinders 26, 32, and 34 in a first direction (e.g., in an extending direction) and movement of left travel motor 42L may be implemented in a similar manner. Likewise, motion of swing motor 43 may be regulated through control of pump 66 and spool position control of valve 84.

The motion of right-travel motor 42R may be reversed by switching the operation of metering valves 76-82. In particular, metering valves 76 and 82 may be moved to their flow-blocking positions and metering valves 78, 80 simultaneously moved an extent toward their flow-passing positions such that, although the flow direction of fluid within second circuit 64 may remain the same, the flow direction through right-travel motor 42R may be reversed. Movement of hydraulic cylinders 26, 32, and 34 in a second direction (e.g., in a retracting direction) and movement of left travel motor 42L may be implemented in a similar manner. Likewise, motion of swing motor 43 in a second direction may be switching the spool position of valve 84.

When the operator desires to simultaneously move multiple actuators within a single circuit, speed and direction control of the actuators may be independently controlled by metering fluid into and out of at least one of the actuators. In particular, pump control (i.e., displacement control of pump 66) may be used to regulate the net flow within a common circuit. And in order to regulate each actuator within the same circuit, metering valves 76-82 and/or spool valve 84 associated with the actuator(s) must be used to independently switch movement directions of the actuator(s) and to independently regulate flow rates into and out of the actuator(s) through throttling. It is contemplated that the metering valves 76-82 and/or 84 of all actuators within a single circuit may be utilized, if desired, to independently control the movement speeds. Although throttling the fluid flows to all actuators of a single circuit may adequately control the movement speeds of the actuators, these vales may increase throttling losses but enable fewer and smaller pumps and associated losses.

In the disclosed embodiments of hydraulic system 56, flows provided by pumps 66 may be substantially unrestricted during many operations such that significant energy is not unnecessarily wasted in the actuation process. Thus, embodiments of the disclosure may provide improved energy usage and conservation. In addition, the disclosed configurations may allow for a reduction in the number of pumps required within hydraulic system 56 and/or a size and capacity of these pumps. These reductions may improve packaging of hydraulic system 56 and/or reduce a cost of hydraulic system 56.

It will be apparent to those skilled in the art that various modifications and variations can be made to the disclosed hydraulic system. Other embodiments will be apparent to those skilled in the art from consideration of the specification and practice of the disclosed hydraulic system. It is intended that the specification and examples be considered as exemplary only, with a true scope being indicated by the following claims and their equivalents.

What is claimed is:

1. A hydraulic system, comprising:
a first circuit fluidly connecting a first pump to a swing motor and to a first travel motor in a parallel closed-loop manner; and
a second circuit fluidly connecting a second pump to a second travel motor and to a first linear tool actuator in a parallel closed-loop manner.

2. The hydraulic system of claim 1, wherein the first circuit further fluidly connects the first pump to a second linear tool actuator in a closed-loop manner, in parallel with the swing motor and first travel motor.

3. The hydraulic system of claim 2, wherein the second circuit further fluidly connects the second pump to a pair of tandem-operating third linear tool actuators in a closed-loop manner.

4. The hydraulic system of claim 3, further including:
at least a first metering valve associated with the swing motor;
at least a second metering valve associated with the first travel motor;
at least a third metering valve associated with the second travel motor;
at least a fourth metering valve associated with the first linear tool actuator;
at least a fifth metering valve associated with the second linear tool actuator; and
at least a sixth metering valve associated with the third linear tool actuators.

5. The hydraulic system of claim 4, wherein the at least a fourth and at least a fifth, metering valves each includes a set of four independent metering valves.

6. The hydraulic system of claim 5, wherein the at least a first metering valve includes a spool type valve movable between a first flow-passing position, a flow-blocking position, and a second flow-passing position.

7. The hydraulic system of claim 4, further including a controller in communication with the first pump, the second pump, the swing motor, the at least a first metering valve, the at least a second metering valve, the at least a third metering valve, the at least a fourth metering valve, the at least a fifth metering valve, and the at least a sixth metering valve.

8. The hydraulic system of claim 3, wherein the first pump has a capacity about equal to a capacity of the second pump.

9. The hydraulic system of claim 3, wherein the first pump has a capacity greater than a capacity of the second pump.

10. The hydraulic system of claim 3, wherein each of the first and second pumps are unidirectional variable-displacement pumps.

11. The hydraulic system of claim 10, wherein each of the first and second travel motors are fixed displacement motors.

12. The hydraulic system of claim 11, wherein the swing motor is an over-center variable-displacement motor.

13. The hydraulic system of claim 3, wherein each of the swing motor, first travel motor, first linear actuator, second linear actuators, and third linear actuator are simultaneously operable.

14. The hydraulic system of claim 3, wherein the first and second circuits include only the first and second pumps as sole sources of pressurized fluid.

15. The hydraulic system of claim 3, wherein:
the first linear tool actuator is a bucket actuator;
the second linear tool actuator is a stick actuator; and
the tandem-operating third linear tool actuators are boom actuators.

16. The hydraulic system of claim 3, wherein each of the swing motor, first travel motor, first linear tool actuator, second travel motor, second linear tool actuator, and third linear tool actuators are simultaneously operable.

17. A hydraulic system, comprising:
a first circuit fluidly connecting a unidirectional variable-displacement first pump to an over-center variable-displacement swing motor in a closed-loop manner, a fixed-displacement first travel motor, and a first linear tool actuator in a parallel closed-loop manner;
a second circuit fluidly connecting a unidirectional variable-displacement second pump to a fixed-displacement first travel motor, a second linear tool actuator, and a pair of tandem-operating third linear tool actuators in a parallel closed-loop manner;
at least a first metering valve associated with the swing motor;
at least a second metering valve associated with the first travel motor;
at least a third metering valve associated with the first linear tool actuator;
at least a fourth metering valve associated with the second travel motor;
at least a fifth metering valve associated with the second linear tool actuator; and
at least a sixth metering valve associated with the third linear tool actuators,
wherein each of the swing motor, first travel motor, first linear tool actuator, second travel motor, second linear tool actuator, and third linear tool actuators are simultaneously operable.

18. A method of operating a hydraulic system, comprising:
pressurizing fluid with a first pump and a second pump;
directing fluid from the first pump to a swing motor and to a first travel motor, and from the swing and travel motors back to the first pump via a closed-loop first circuit; and
directing fluid from the second pump to a first travel motor and to a first linear tool actuator in parallel, and from travel motor and the first linear tool actuator back to the second pump via a closed-loop second circuit.

19. The method of claim 18, further including directing fluid from the first pump to a second linear tool actuator in a closed-loop manner, in parallel with the swing motor and first travel motor.

20. The method of claim 18, further including directing fluid from the second pump to a pair of tandem-operating third linear tool actuators in a closed-loop manner, in parallel with the second travel motor and first linear tool actuator.
